(19) United States
(12) Patent Application Publication
(10) Pub. No.: US 2019/0356973 A1
(43) Pub. Date: Nov. 21, 2019

(54) ULTRASONIC WAVE OUTPUT DEVICE

(71) Applicant: DENSO CORPORATION, Kariya-city (JP)

(72) Inventor: Toshiaki NAKAYAMA, Kariya-city (JP)

(21) Appl. No.: 16/524,346

(22) Filed: Jul. 29, 2019

Related U.S. Application Data
(63) Continuation of application No. PCT/JP2018/002493, filed on Jan. 26, 2018.

(30) Foreign Application Priority Data
Feb. 1, 2017 (JP) 2017-016808

(51) Int. Cl. H04R 1/02; B06B 1/02

(52) U.S. Cl. CPC H04R 1/02; B06B 1/02

(57) ABSTRACT

An ultrasonic wave output device includes a plurality of ultrasonic wave output units, a hold unit, and a tubular unit. The plurality of ultrasonic wave output units output ultrasonic waves in a traveling direction set in advance in response to an input signal. The hold unit holds the plurality of ultrasonic wave output units. The tubular unit surrounds the plurality of ultrasonic wave output units in a direction orthogonal to the traveling direction. The tubular unit is connected to the hold unit.

### CROSS REFERENCE TO RELATED APPLICATIONS

The present application is a continuation application of International Patent Application No. PCT/JP2018/002493 filed on Jan. 26, 2018, which designated the United States and claims the benefit of priority from Japanese Patent Application No. 2017-016808 filed on Feb. 1, 2017. The entire disclosures of all of the above applications are incorporated herein by reference.

### TECHNICAL FIELD

The present disclosure relates to an ultrasonic wave output device that outputs an ultrasonic wave.

### BACKGROUND

An ultrasonic wave output unit installed on a hold unit such as a pedestal has been proposed.

### SUMMARY

The present disclosure provides an ultrasonic wave output device. The ultrasonic wave output device includes at least one ultrasonic wave output unit, a hold unit, and a tubular unit. The at least one ultrasonic wave output unit may output an ultrasonic wave in a traveling direction set in advance in response to an input signal. The hold unit may hold the at least one ultrasonic wave output unit. The tubular unit may surround the at least one ultrasonic wave output unit in a direction orthogonal to the traveling direction. The hold unit may be connected to the tubular unit.

### BRIEF DESCRIPTION OF DRAWINGS

The above and other objects, features and advantages of the present disclosure will become more apparent from the following detailed description made with reference to the accompanying drawings. In the drawings:

FIG. 1 is a cross-sectional view of an ultrasonic wave output device taken along a line I-I in FIG. 2 according to a first embodiment;

FIG. 2 is a front view of the ultrasonic wave output device according to the first embodiment;

FIG. 3 is a perspective view of the ultrasonic wave output device according to the first embodiment;

FIG. 4 is a cross-sectional view of an ultrasonic wave output device taken along a line IV-IV in FIG. 5 according to a second embodiment;

FIG. 5 is a front view of the ultrasonic wave output device according to the second embodiment; and

FIG. 6 is a perspective view of the ultrasonic wave output device according to the second embodiment.

### DETAILED DESCRIPTION

For example, vibration generated when an ultrasonic wave is output from the ultrasonic wave output unit is transmitted to surrounding members supporting the ultrasonic wave output unit. The inventor has found that there is a difficulty that the configuration causes an energy loss and the output characteristics of the ultrasonic wave such as directivity is unstable.

An example embodiment of the present disclosure provides an ultrasonic wave output device that stabilizes output characteristics of ultrasonic wave.

In an example embodiment of the present disclosure, an ultrasonic wave output device includes a plurality of ultrasonic wave output units, a hold unit, and a tubular unit. The plurality of ultrasonic wave output units output ultrasonic waves in a traveling direction set in advance in response to an input signal. The hold unit holds the plurality of ultrasonic wave output units. The tubular unit surrounds the plurality of ultrasonic wave output units in a direction orthogonal to the traveling direction. The tubular unit is connected to the hold unit.

With the ultrasonic wave output device, since the hold unit is connected to the tubular unit, the rigidity of the hold unit can be improved. Since the configuration can make the vibration generated by the ultrasonic wave hard to be transmitted to the hold unit, the output characteristic of the ultrasonic wave can be stabilized.

Embodiments of the present disclosure will be described below with reference to the drawings.

### 1. First Embodiment

### 1-1. Configuration

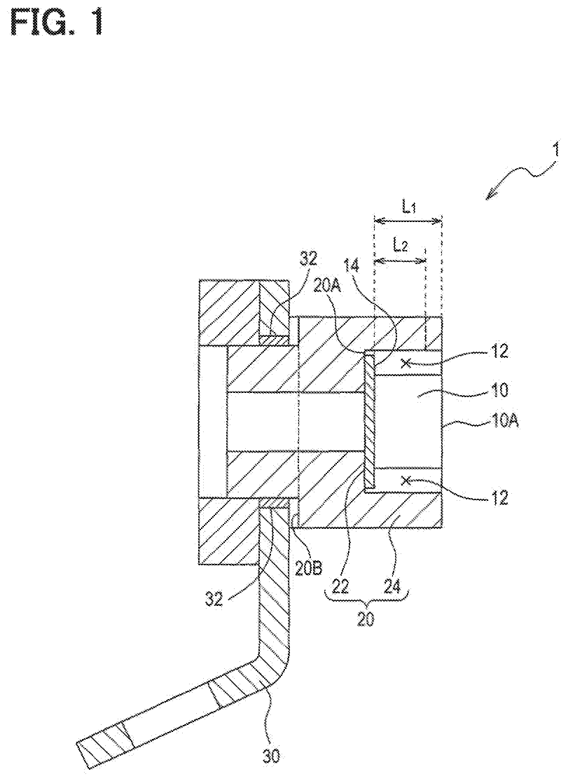

An ultrasonic wave output device 1 according to a first embodiment shown in FIGS. 1 to 3 is a device that outputs an ultrasonic wave. The ultrasonic wave output device 1 includes an ultrasonic wave output unit 10 and a case unit 20. The ultrasonic wave output unit 10, as a parametric speaker, outputs an audible sound by the ultrasonic wave.

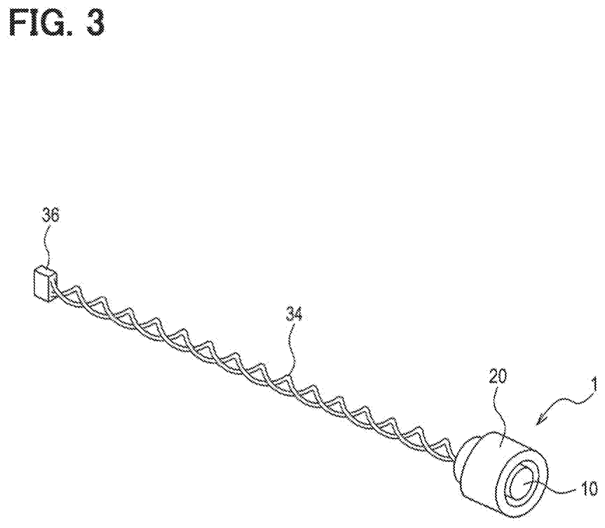

The ultrasonic wave output unit 10 receives an input signal from an ultrasonic wave amplifier (not shown) via a lead 34 with a connector 36 shown in FIG. 3. The ultrasonic wave output unit 10 outputs the audible sound having directivity in response to the input signal. As the input signal, a signal capable of outputting a predetermined audible sound by modulating the amplitude of the waveform of the ultrasonic wave, which has a predetermined frequency (for example, 40 kHz) and constant amplitude, is input.

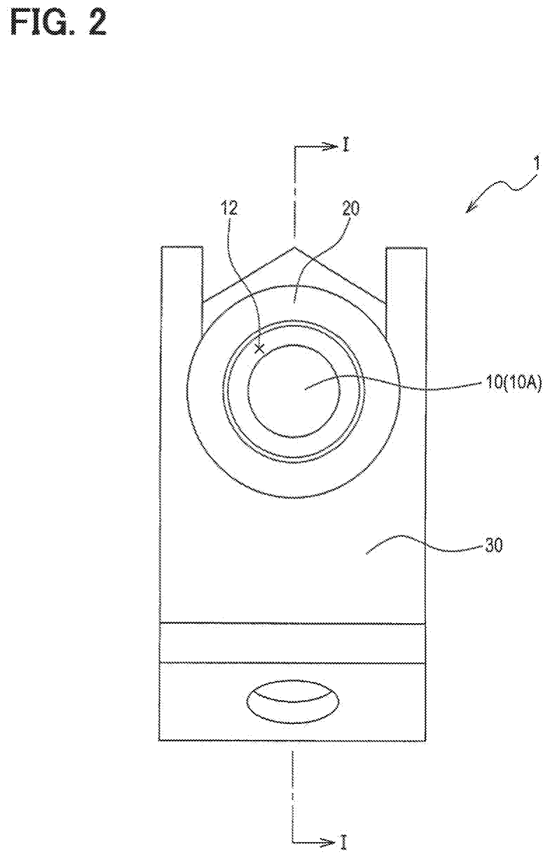

As shown in FIGS. 1 to 3, the ultrasonic wave output unit 10 has a column shape. The ultrasonic wave output unit 10 outputs the ultrasonic wave from a sound wave output surface 10A, which is one end surface, to a traveling direction in response to the input signal. The traveling direction is set perpendicular to the sound wave output surface 10A. The traveling direction is directed to right in FIG. 1, and toward the front side of the drawing paper in FIG. 2. FIGS. 1 to 3 show an example in which one ultrasonic wave output unit 10 is provided. Alternatively, a plurality of ultrasonic wave output units 10 may be provided.

The case unit 20 is made of, for example, a metal such as stainless steel, aluminum alloy, or the like, and is a member that surrounds and holds the ultrasonic wave output unit 10. The case unit 20 has a cylindrical shape, and a step 20A and a step 20B are respectively provided on an inner diameter unit and an outer diameter unit. In the case unit 20, the inner diameter and the outer diameter on the traveling direction side are respectively increased at the steps 20A, 20B.

The column shape and cylindrical shape respectively include substantially column shape and substantially cylindrical shape. Further, the step 20A in the inner diameter functions as the hold unit 22. The hold unit 22 holds a surface of the ultrasonic wave output unit 10 which faces opposite to the traveling direction directly or indirectly via another member. In the present embodiment, the hold unit 22 holds the ultrasonic wave output unit 10 via a buffer member 14 described later.

A part of the case 20 having a larger inner diameter functions as a tubular unit 24. The tubular unit 24 surrounds the ultrasonic wave output unit 10 in the direction orthogonal to the traveling direction. A clearance 12 is provided between the tubular unit 24 and the ultrasonic wave output unit 10 such that the tubular unit 24 and the ultrasonic wave output unit 10 have a constant distance. The clearance 12 makes it difficult for the vibration of the ultrasonic wave output unit 10 to be transmitted to the tubular unit 24. In the case unit 20, the tubular unit 24 is integrated with the hold unit 22.

The length L1 from the hold unit 22 to the end of the tubular unit 24 in the traveling direction is equal to the length L1 from the hold unit 22 to the sound wave output surface 10A of the ultrasonic wave output unit 10. Alternatively, the length from the hold unit 22 to the end of the tubular unit 24 on the traveling direction may be set to the length L2 that is shorter than the length L1 from the hold unit 22 to the sound wave output surface 10A of the ultrasonic wave output unit 10.

The ultrasonic wave output device 1 further includes the buffer member 14 between the ultrasonic wave output unit 10 and the hold unit 22. The buffer member 14 is made of a material softer than the hold unit 22. As to whether the buffer member 14 and a vibration suppression member 32 described later are made of hard or soft materials, the material that easily absorbs the ultrasonic wave vibration is defined as the softer material.

As an example for strictly measuring whether the material is hard or soft, preparing samples having the same shape, vibrating the samples by fixing one end of each sample, applying a load to another end, and releasing another end. In this measurement, a material having a low frequency is employed as a softer material. For example, a gasket made of resin such as rubber, a rubber plate, a rubber-based adhesive, or the like can be employed as the buffer member 14.

The ultrasonic wave output device 1 further includes a support unit 30 and the vibration suppression member 32. The support unit 30 supports the case unit 20 in a state in which the ultrasonic wave output unit 10 is held. The support unit 30 supports the case unit 20 via the vibration suppression member 32 on the rear side of the traveling direction with respect to the step 20B of the outer diameter in the case unit 20.

The vibration suppression member 32 is a member having a ring shape and arranged between the hold unit 22 and the support unit 30, and is made of a material softer than the hold unit 22.

### 1-2. Effects

According to the first embodiment detailed above, the following effects may be obtained.

(1a) The ultrasonic wave output device 1 includes the ultrasonic wave output unit 10, the hold unit 22, and the tubular unit 24. At least one the ultrasonic wave output unit 10 is provided. The at least one the ultrasonic wave output unit 10 outputs the ultrasonic wave in the traveling direction set in advance in response to the input signal. The hold unit 22 holds the ultrasonic wave output unit 10. The tubular unit 24 surrounds the ultrasonic wave output unit 10 in the direction orthogonal to the traveling direction. The tubular unit 24 is connected to the hold unit 22.

With the above described ultrasonic wave output device 1, 2, since the hold unit 22 is connected to the tubular unit 24, the rigidity of the hold unit 22 can be improved. With this configuration, since the vibration by the ultrasonic wave can be made hard to be transmitted to the hold unit 22, the output characteristic of the ultrasonic wave can be stabilized.

(1b) The above described ultrasonic output device 1 further includes the buffer member 14, which is made of a material softer than the hold unit 22, arranged between the ultrasonic wave output unit 10 and the hold unit 22. With the above described ultrasonic wave output device 1, since the vibration can be absorbed by the buffer member 14, the vibration by the ultrasonic wave can be made more difficult to be transmitted to the hold unit 22.

(1b) The above described ultrasonic output device 1 further includes the support unit 30 that supports the hold unit 22, and the vibration suppression member 32, which is made of a material softer than the hold unit 22, arranged between the hold unit 22 and the support unit 30.

With the above described ultrasonic wave output device 1 having the support unit 30, the arrangement of the vibration suppression member 32 can make it difficult to transmit the vibration by the ultrasonic wave to be transmitted to the support unit 30.

(1d) In the above described ultrasonic wave output device 1, the length L2 form the hold unit 22 to the end of the tubular unit 24 in the traveling direction is set equal to or less than the length L1 from the hold unit 22 to the sound wave output surface 10A of the ultrasonic wave output unit 10.

The length L2 form the hold unit 22 to the end of the tubular unit 24 in the traveling direction is equal to or less than the length L1 from the hold unit 22 to the sound wave output surface 10A of the ultrasonic wave output unit 10 so that the above described ultrasonic wave output device 1 can prevent the ultrasonic wave from being interfered by reflection on the tubular unit 24, or the like.

### Second Embodiment

### 2-1. Main Difference from the First Embodiment

Since the basic configuration of a second embodiment is similar to the first embodiment, the main difference will be described below. Note that the same reference numerals as those in the first embodiment indicate the same configuration, and refer to the preceding descriptions.

In the first embodiment described above, an example in which one ultrasonic wave output unit 10 is provided has been described. On the other hand, the second embodiment is different from the first embodiment in that a plurality of ultrasonic wave output units 10 are provided.

### 2-2. Configuration

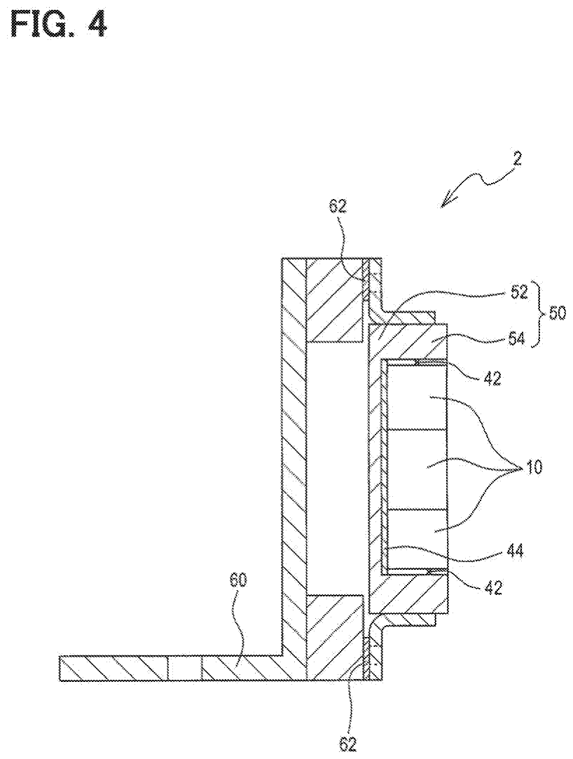

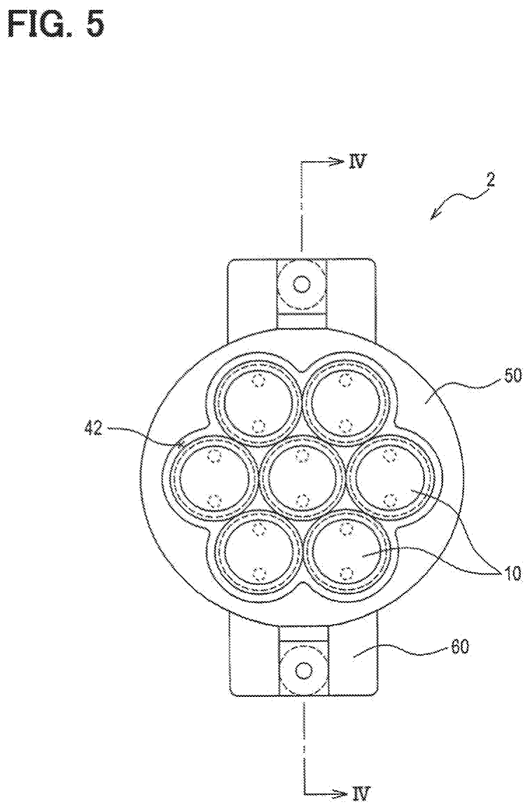

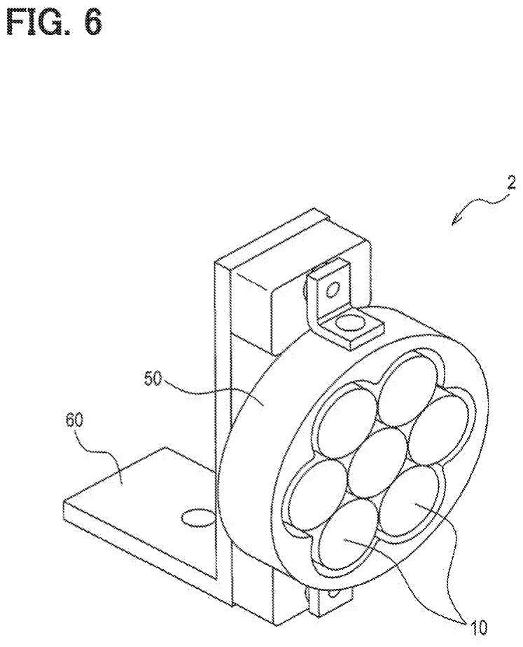

As shown in FIGS. 4, 5 and 6, the ultrasonic wave output device 2 includes a plurality of ultrasonic wave output units 10. The input signals having the same frequency and the same phase are input to the plurality of ultrasonic wave output units 10.

Instead of the case unit 20 having the hold unit 22 and the tubular unit 24 described above, a case unit 50 having a hold unit 52 and a tubular unit 54 is included. Instead of the buffer member 14, the support unit 30, and the vibration suppression member 32 described above, a buffer member 44, a support unit 60, and a vibration suppression member 62 are respectively included.

The hold unit 52, the tubular unit 54, the buffer member 44, the support unit 60, and the vibration suppression member 62 are substantially the same as the hold unit 22, the tubular unit 24, the buffer member 14, the support unit 30, and the vibration suppression member 32 described above.

The plurality of ultrasonic wave output units 10 are arranged so as not to have gap between adjacent two of the plurality of ultrasonic wave output units 10. Specifically, six ultrasonic wave output units 10 are arranged around one ultrasonic wave output unit 10. In the tubular unit 54, the cross sectional shape of the inner wall corresponds to the shape of the outer wall of the plurality of ultrasonic wave output units 10 that are arranged. A clearance 42 is provided between the inner wall of the tubular unit 54 and the outer wall of the plurality of ultrasonic wave output units 10 such that the inner wall of the tubular unit 54 and the outer wall of the plurality of ultrasonic wave output units 10 have a constant distance. The buffer member 44 is in contact with the surfaces of all the plurality of ultrasonic wave output units 10, which face opposite in the traveling direction.

### 2-3. Effects

The detailed second embodiment provides the effect (1a) according to the above described first embodiment and the following effects.

(2a) The ultrasonic wave output device 2 includes the plurality of ultrasonic wave output units 10. In the tubular unit 54, the cross sectional shape of the inner wall corresponds to the shape of the outer wall of the plurality of ultrasonic wave output units 10 that are arranged.

With the ultrasonic wave output device 2, the inner wall of the tubular unit 54 corresponds to the outer wall of the plurality of ultrasonic wave output units 10 so that a part of the tubular unit 54 can be thick according to the shape of the plurality of ultrasonic wave output units 10. With this configuration, the rigidity of the tubular unit 54 can be improved.

(2b) In the ultrasonic wave output device 2, the plurality of ultrasonic wave output units 10 are arranged so as not to have gap between adjacent two of the plurality of ultrasonic wave output units 10.

With the ultrasonic wave output device 2, the plurality of ultrasonic wave output units 10 are arranged so as not to have gap between adjacent two of the plurality of ultrasonic wave output units 10 so that the variation in the characteristics is suppressed and the plurality of ultrasonic wave output units 10 can be easily used as one ultrasonic wave output unit 10.

### 3. Other Embodiments

Although the embodiments of the present disclosure have been described above, the present disclosure is not limited to the embodiments described above, and various modifications can be made to implement the present disclosure.

(3a) In the above described second embodiment, the input signals having the same phase are input to the plurality of ultrasonic wave output units 10, however the present disclosure is not limited thereto. For example, input signals having the same frequency but the different phases may be input to the plurality of ultrasonic wave output units 10. In this configuration, output ultrasonic waves are interfered with each other so that directivity is changed.

(3b) In the above described embodiment, the buffer member 14, 44 and the vibration suppression member 32, 62 are provided. Alternatively, at least one of the buffer member 14, 44 and the vibration suppression member 32, 62 is not an essential component.

(3c) A plurality of functions of one element in the above embodiment may be implemented by a plurality of elements, or one function of one element may be implemented by a plurality of elements. Further, a plurality of functions of a plurality of elements may be implemented by one element, or one function implemented by a plurality of elements may be implemented by one element. A part of the configuration of the above embodiment may be omitted. At least a part of the configuration of the above embodiment may be added to or replaced with another configuration of the above embodiment. All modes included in the technical idea identified by the wording described in the claims correspond to embodiments of the present disclosure.

(3d) In addition to the above described ultrasonic wave output devices 1, 2, the present disclosure can be implemented in various forms such as a system which includes the ultrasonic wave output device 1, 2 as a component.

1. An ultrasonic wave output device comprising:
a plurality of ultrasonic wave output units configured to output ultrasonic waves in a traveling direction set in advance in response to an input signal;
a hold unit that holds the plurality of ultrasonic wave output units; and
a tubular unit that surrounds the plurality of ultrasonic wave output units in a direction orthogonal to the traveling direction, and connected to the hold unit,
wherein:
the tubular unit has an inner wall of which a cross sectional shape corresponds to a shape of an outer wall of the plurality of ultrasonic wave output units that are arranged; and
the plurality of ultrasonic wave output units are arranged not to have a gap between adjacent two of the plurality of ultrasonic wave output units.

2. The ultrasonic wave output device according to claim 1, further comprising
a buffer member arranged between the plurality of ultrasonic wave output units and the hold unit, and made of a material softer than the hold unit.

3. The ultrasonic wave output device according to claim 1, further comprising:
a support unit that supports the hold unit; and
a vibration suppression member arranged between the hold unit and the support unit, and made of a material softer than a material of the hold unit.

4. The ultrasonic wave output device according to claim 1, wherein the tubular unit has a length in the traveling direction from the hold unit to an end of the tubular unit equal to or less than a length from the hold unit to a sound wave output surface of each of the plurality of ultrasonic wave output units.
